(19) United States
(12) Patent Application Publication
(10) Pub. No.: US 2025/0153513 A1
(43) Pub. Date: May 15, 2025

(54) TIRE

(71) Applicant: Sumitomo Rubber Industries, Ltd., Hyogo (JP)

(72) Inventor: Hiroki HOKAZONO, Kobe-shi (JP)

(73) Assignee: Sumitomo Rubber Industries, Ltd., Hyogo (JP)

(21) Appl. No.: 18/925,599

(22) Filed: Oct. 24, 2024

(30) Foreign Application Priority Data
Nov. 9, 2023 (JP) 2023-191758

(51) Int. Cl. B60C 11/03

(52) U.S. Cl. CPC B60C 11/0306; B60C 11/033; B60C 2011/0339

(57) ABSTRACT

A tire 1 includes a pair of shoulder block rows 4, 4 and a plurality of crown blocks 5. The crown blocks 5 include a plurality of first crown blocks 7 and a plurality of second crown blocks 8 which are disposed such that a second crown block pair 9 having the two second crown blocks 8 disposed adjacent to each other in the tire axial direction repeatedly appears in the tire circumferential direction. Each first crown block 7 is disposed one by one between the second crown block pairs 9 adjacent to each other in the tire circumferential direction. The first crown block 7 has a laterally elongated tread surface 7a in which the maximum length L1 is less than the maximum width W1. The second crown block 8 has a longitudinally elongated tread surface 8a in which the maximum length L2 is greater than the maximum width W2.

### BACKGROUND OF THE INVENTION

### Field of the Invention

The present invention relates to a tire.

### Background Art

Japanese Laid-Open Patent Publication No. 2020-82904 discloses a tire in which a plurality of middle blocks are disposed in a crown region. It is indicated that, in the plurality of middle blocks, the length in the tire circumferential direction is greater than the length in the tire axial direction.

It is indicated that, in the tire disclosed in Japanese Laid-Open Patent Publication No. 2020-82904, stiffness in the tire circumferential direction is enhanced, and wear resistance is enhanced. However, in such a tire, there is room for examination of reduction of sideslip (side skid) during running.

The present invention has been made in view of the aforementioned problem, and a main object of the present invention is to provide a tire that allows reduction of sideslip while enhancing wear resistance.

### SUMMARY OF THE INVENTION

The present invention is directed to a tire including a tread portion, and, in the tire, the tread portion includes a pair of shoulder block rows, and a plurality of crown blocks disposed between the pair of shoulder block rows, the crown blocks include a plurality of first crown blocks and a plurality of second crown blocks, the plurality of second crown blocks are disposed such that a second crown block pair in which the two second crown blocks are disposed adjacent to each other in a tire axial direction so as to overlap each other in a tire circumferential direction repeatedly appears in the tire circumferential direction, each of the plurality of first crown blocks is disposed one by one between the second crown block pairs adjacent to each other in the tire circumferential direction, each of the plurality of first crown blocks has a laterally elongated tread surface in which a maximum length in the tire circumferential direction is less than a maximum width in the tire axial direction, and each of the plurality of second crown blocks has a longitudinally elongated tread surface in which a maximum length in the tire circumferential direction is greater than a maximum width in the tire axial direction.

The tire of the present invention has the above-described configuration, and can thus reduce sideslip while enhancing wear resistance.

### BRIEF DESCRIPTION OF THE DRAWINGS

FIG. 1 is a plan view of a tread portion of a tire according to one embodiment of the present invention;

FIG. 2 is a plan view of a first crown block;

FIG. 3A is a cross-sectional view taken along a line A-A in FIG. 2, and FIG. 3B is a cross-sectional view taken along a line B-B in FIG. 4;

FIG. 4 is a plan view of a second crown block pair;

FIG. 5 is a plan view of a shoulder block; and

FIG. 6 is a cross-sectional view taken along a line C-C in FIG. 5.

### DETAILED DESCRIPTION

An embodiment of the present invention will be described below with reference to the drawings. The drawings include exaggerated expressions and the dimensional ratio in the drawings is expressed so as to be different from that of the actual structure in order to aid in understanding of the present invention. In a case where a plurality of embodiments are described, the same or common components are denoted by the same reference characters throughout the description, and repeated description is omitted.

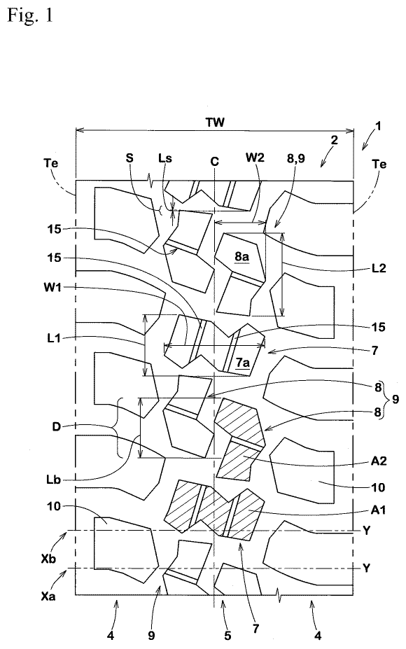

FIG. 1 is a plan view of a tread portion 2 of a tire 1 according to one embodiment of the present invention. The present invention is suitably applied to a pneumatic tire for an SUV which is intended also for off-road running such as running on a muddy road surface and a rocky road surface. However, the present invention may also be applied to a pneumatic tire for a light truck, a heavy-duty pneumatic tire, or a non-pneumatic tire which is not inflated with pressurized air.

In the description herein, unless otherwise specified, dimensions and the like of components of the tire 1 are represented as values measured in a standardized state. The “standardized state” refers to a state in which the tire 1 is mounted on a standardized rim (not shown) and is inflated to a standardized internal pressure and no load is applied to the tire 1, in the case of a pneumatic tire. For non-pneumatic tires and tires for which various standards are not defined, the standardized state refers to a standard use state, corresponding to a purpose of use of the tire, in which the tire is not mounted to a vehicle and no load is applied to the tire.

The “standardized rim” refers to a rim that is defined, in a standard system including a standard on which the tire 1 is based, by the standard for each tire, and is, for example, “standard rim” in the JATMA standard, “Design Rim” in the TRA standard, or “Measuring Rim” in the ETRTO standard.

The “standardized internal pressure” refers to an air pressure that is defined, in a standard system including a standard on which the tire 1 is based, by the standard for each tire, and is “maximum air pressure” in the JATMA standard, the maximum value recited in the table “TIRE LOAD LIMITS AT VARIOUS COLD INFLATION PRESSURES” in the TRA standard, or “INFLATION PRESSURE” in the ETRTO standard.

The tread portion 2 includes a pair of shoulder block rows 4, 4, and a plurality of crown blocks 5 disposed between the pair of shoulder block rows 4.

The crown blocks 5 include a plurality of first crown blocks 7 and a plurality of second crown blocks 8.

The plurality of second crown blocks 8 are disposed such that a second crown block pair 9 in which the two second crown blocks 8 are disposed adjacent to each other in the tire axial direction so as to overlap each other in the tire circumferential direction repeatedly appears in the tire circumferential direction. The “overlap in the tire circumferential direction” means that a length Lb, in the tire circumferential direction, of an overlapping portion D in which the two second crown blocks 8 overlap each other in the tire circumferential direction is 60% or more of the maximum length L2 of the second crown block 8 in the tire circumferential direction, and also means that the two second crown blocks 8 overlap each other over 65% or more of the maximum length L2.

Each of the plurality of second crown blocks 8 has a longitudinally elongated tread surface 8a in which the maximum length L2 in the tire circumferential direction is greater than the maximum width W2 in the tire axial direction. The second crown block 8 having such a configuration exhibits basic wear resistance. In the description herein, the “tread surface” refers to a surface that comes into contact with a plane as described below in a standardized load applied state as described below.

Each of the plurality of first crown blocks 7 is disposed one by one between the second crown block pairs 9 adjacent to each other in the tire circumferential direction. In other words, the first crown block 7 and the second crown block pair 9 alternate in the tire circumferential direction. In the description herein, the “alternate in the tire circumferential direction” means that a length Ls, in the tire circumferential direction, of an overlapping portion S in which the second crown block pair 9 and the first crown block 7 overlap each other in the tire circumferential direction is 3% or less of a tread width TW. The second crown block pair 9 and the first crown block 7 may not overlap each other in the tire circumferential direction at all (not shown).

The tread width TW represents a length in the tire axial direction between tread ends Te and Te. The tread end Te is defined as the outermost ground contact position in the tire axial direction in a standardized load applied state. The “standardized load applied state” represents a state in which a standardized load is applied to the tire 1 in the standardized state, and the tire 1 is brought into contact with a plane at a camber angle of 0°.

The “standardized load” refers to a load that is defined, in a standard system including a standard on which the tire is based, by the standard for each tire, and is “maximum load capacity” in the JATMA standard, the maximum value recited in the table “TIRE LOAD LIMITS AT VARIOUS COLD INFLATION PRESSURES” in the TRA standard, or “LOAD CAPACITY” in the ETRTO standard, for pneumatic tires for which various standards are defined. For tires for which various standards are not defined, the “standardized load” refers to the maximum load that is applicable when the tire is used, in accordance with the above-described standard.

Each of the plurality of the first crown blocks 7 has a laterally elongated tread surface 7a in which the maximum length L1 in the tire circumferential direction is less than the maximum width W1 in the tire axial direction. The first crown block 7 having such a configuration has high stiffness in the tire axial direction, and thus allows sideslip to be reduced during running. In the present embodiment, the first crown block 7 can particularly inhibit sideslip from occurring also when side camber is generated in off-road running. One first crown block 7 is disposed between the second crown block pairs 9 adjacent to each other in the tire circumferential direction. Therefore, a block having high stiffness in the tire circumferential direction and a block having high stiffness in the tire axial direction alternate in the tire circumferential direction. Thus, an effect of reducing the frequency and the extent (degree) of sideslip (hereinafter, may be referred to as “sideslip resistance”) and an effect of enhancing wear resistance are alternately exhibited, so that sideslip can be more effectively reduced while wear resistance is enhanced.

A ratio (L1/W1) of the maximum length L1 of the laterally elongated tread surface 7a in the tire circumferential direction to the maximum width W1 of the laterally elongated tread surface 7a in the tire axial direction is preferably 0.4 or more and more preferably 0.5 or more, and preferably 0.8 or less and more preferably 0.7 or less. Since the ratio (L1/W1) is 0.4 or more, stiffness of the first crown block 7 in the tire circumferential direction is ensured, and wear resistance is maintained. Since the ratio (L1/W1) is 0.8 or less, sideslip resistance is enhanced. The maximum width W1 of the laterally elongated tread surface 7a is preferably 25% or more of the tread width TW and more preferably 30% or more thereof, and is preferably 45% or less thereof and more preferably 40% or less thereof.

In order to effectively exhibit the above-described effect, a ratio (L2/W2) of the maximum length L2 of the longitudinally elongated tread surface 8a in the tire circumferential direction to the maximum width W2 of the longitudinally elongated tread surface 8a in the tire axial direction is preferably 1.3 or more, more preferably 1.4 or more, and even more preferably 1.5 or more, and preferably 2.0 or less, more preferably 1.9 or less, and even more preferably 1.8 or less. The maximum width W2 of the longitudinally elongated tread surface 8a is preferably 10% or more of the tread width TW and more preferably 15% or more thereof, and preferably 30% or less thereof and more preferably 25% or less thereof.

An absolute value |A1-A2| of a difference between an area A1 of the tread surface 7a of the first crown block 7 and an area A2 of the tread surface 8a of each second crown block 8 is preferably 40% or less of a smaller one of the area A1 or the area A2. Thus, the difference between the area A1 of the tread surface 7a of the first crown block 7 and the area A2 of the tread surface 8a of the second crown block 8 is reduced, and a difference between stiffness by the crown block 7 and stiffness by the crown block 8 in the tire circumferential direction is reduced, so that high wear resistance is maintained. From such a viewpoint, the absolute value |A1-A2| is more preferably 35% or less of a smaller one of the area A1 or the area A2, and more preferably 30% or less thereof. In FIG. 1, the area A1 of the tread surface 7a and the area A2 of the tread surface 8a are hatched. In the present embodiment, the area A1 of the tread surface 7a is larger than the area A2 of the tread surface 8a.

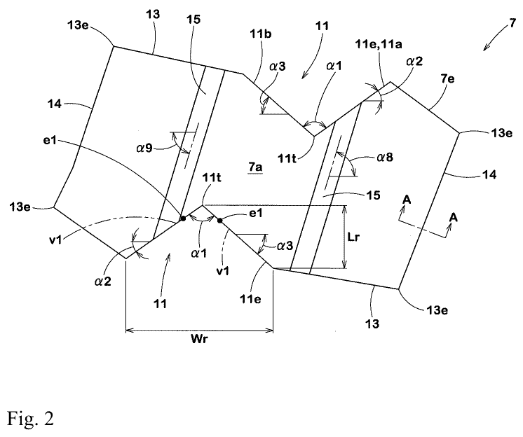

FIG. 2 is a plan view of the first crown block 7. As shown in FIG. 2, each of the plurality of the first crown blocks 7 includes a first crown block edge 7e that defines the tread surface 7a. The first crown block edge 7e includes a recess 11 including a V-shaped edge 11e that is recessed toward the inner side of the tread surface 7a in a planar view of the tread. In the recess 11 having such a configuration, the V-shaped edge 11e allows a shearing force to be exhibited with respect to a muddy road surface, and also allows a scratching force to be exhibited with respect to a rocky road surface, etc., so that off-road running stability is enhanced. In the present embodiment, the recess 11 has a vertex 11t disposed at the innermost side (centroid side) of the tread surface 7a.

An angle α1 formed by the V-shaped edge 11e is 80 to 120° in the present embodiment. Since the angle α1 is 80° or more, concentration of load acting on the vertex 11t can be inhibited, so that chipping in which the block (the first crown block 7) is chipped can be inhibited. Since the angle α1 is 120° or less, muddy soil on a muddy road surface can be smoothly collected into the recess 11, so that a shearing force can be enhanced. From such a viewpoint, the angle α1 is preferably 90° or more and preferably 110° or less. In the description herein, the angle α1 represents an angle between imaginary straight lines v1 and v1 connecting between the vertex 11t and two points e1, e1 positioned on both sides of the vertex 11t. The two points e1, e1 are points on the V-shaped edge 11e and are each distant from the vertex 11t by 5 mm.

Two recesses 11 are disposed in the first crown block 7. Thus, the above-described effect is effectively exhibited.

The first crown block edge 7e includes a pair of first lateral edges 13, 13 extending in the tire axial direction, and a pair of first lengthwise edges 14, 14 each connecting between both ends 13e of the first lateral edges 13. The first lengthwise edge 14 extends in the tire circumferential direction. The “extend in the tire axial direction” means extending at an angle of less than 45° relative to the tire axial direction in the description herein. The “extend in the tire circumferential direction” means extending at an angle of 45° or more relative to the tire axial direction in the description herein. In the present embodiment, each first lateral edge 13 continuously extends between both the ends 13e in the tire axial direction. In the present embodiment, each first lengthwise edge 14 continuously extends between both the ends thereof in the tire circumferential direction.

In the present embodiment, the recess 11 is disposed at each first lateral edge 13. The recess 11 having such a configuration allows a shearing force to be exhibited with respect to sideslip, and allows sideslip resistance to be more effectively enhanced. For example, the recess 11 is formed in a laterally elongated shape in which the maximum width Wr in the tire axial direction is greater than the maximum length Lr in the tire circumferential direction. In the present embodiment, the recess 11 is disposed so as to be distant from both the ends 13e of the first lateral edge 13.

The V-shaped edge 11e of the recess 11 includes, for example, a first edge 11a that is inclined relative to the tire axial direction in a first direction, and a second edge 11b that is connected to the first edge 11a and is inclined in the direction opposite to the direction in which the first edge 11a is inclined. In the present embodiment, the edge 11e is formed such that the first edge 11a and the second edge 11b are connected via the vertex 11t. In the present embodiment, the first edge 11a and the second edge 11b linearly extend. For example, each of the first edge 11a and the second edge 11b is continuously inclined at the same angle relative to the tire axial direction. Each of an angle α2 of the first edge 11a relative to the tire axial direction, and an angle α3 of the second edge 11b relative to the tire axial direction is, for example, 30° or more and less than 45°. In the description herein, the “linearly” means that each of the edges 11a and 11b linearly extends, and also means that each of the edges 11a and 11b extends so as to form an arc having a curvature radius of 100 mm or more.

For example, the recess 11 may be disposed at the first lengthwise edge 14. In this case, the recess 11 allows a shearing force to be enhanced in the tire circumferential direction, so that traction performance and braking performance (hereinafter, may be referred to as “traction performance and the like”) are enhanced.

The maximum width Wr of the recess 11 is preferably 0.35 times the maximum width W1 (shown in FIG. 1) of the first crown block 7 or more and more preferably 0.40 times the maximum width W1 or more, and preferably 0.55 times the maximum width W1 or less and more preferably 0.50 times the maximum width W1 or less. Since the maximum width Wr of the recess 11 is 0.35 times the maximum width W1 or more, a high shearing force can be exhibited. Since the maximum width Wr of the recess 11 is 0.55 times the maximum width W1 or less, the first crown block 7 can assuredly have high stiffness.

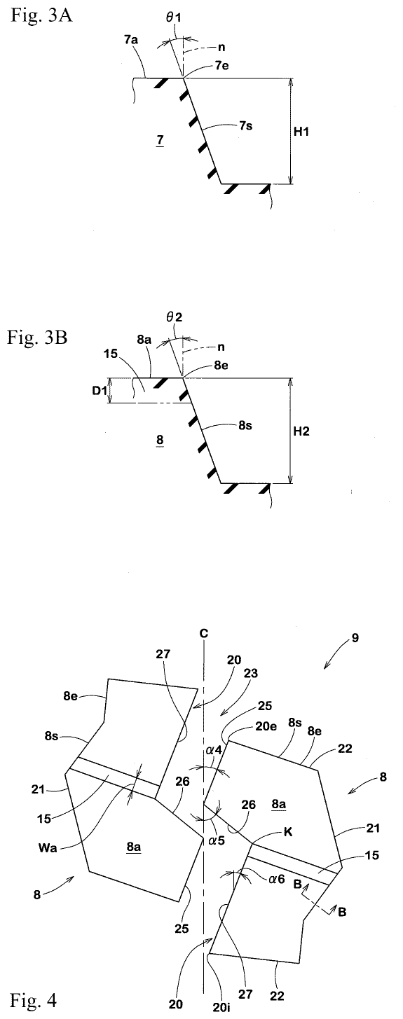

FIG. 3A is a cross-sectional view taken along a line A-A in FIG. 2. As shown in FIG. 3A, each of the plurality of the first crown blocks 7 includes a first block wall surface 7s extending inward from the first crown block edge 7e in the tire radial direction and outward of the tread surface 7a. The first block wall surface 7s is inclined at an angle θ1 of 10 to 20° relative to a tread normal line n that is normal to the tread at the first crown block edge 7e. The first block wall surface 7s having such a configuration contributes to enhancement of stiffness of the first crown block 7 and enhancement of wear resistance and traction performance and the like on an off-road surface.

FIG. 4 is a plan view of the second crown block pair 9. As shown in FIG. 4, the second crown block pair 9 is formed to have a point-symmetric shape such that, when one of the second crown blocks 8 is rotated by 180° around any point on the tire equator C, the one of the second crown blocks 8 coincides with the other of the second crown blocks 8.

The second crown block 8 includes a second crown block edge 8e that defines the tread surface 8a, and a second block wall surface 8s that extends inward from the second crown block edge 8e in the tire radial direction and outward of the tread surface 8a. In the present embodiment, the second crown block edges 8e of the second crown block pair 9 include inner block edges 20, respectively, opposing each other. In other words, a crown longitudinal groove 23 is formed by the inner block edges 20 of the second crown block pair 9. For example, the second crown block edge 8e further includes an outer block edge 21 that is distant from the inner block edge 20 in the tire axial direction, and a pair of lateral block edges 22 that connect between the inner block edge 20 and the outer block edge 21 at both ends in the tire circumferential direction. For example, the outer block edge 21 extends in the tire circumferential direction. Each lateral block edge 22 extends in the tire axial direction.

In the present embodiment, the inner block edge 20 includes a first inclined portion 25 that includes a first end 20e of the inner block edge 20 in the longitudinal direction, and is inclined relative to the tire circumferential direction toward a first side (lower left side in the drawings), and a second inclined portion 26 that is connected to the first inclined portion 25 and is inclined toward the side opposite to the first side. The inner block edge 20 further includes a third inclined portion 27 that is connected to the second inclined portion 26 and is inclined toward the first side. In the present embodiment, the third inclined portion 27 includes a second end 20i of the inner block edge 20 in the longitudinal direction. The first inclined portion 25, the second inclined portion 26, and the third inclined portion 27 are each inclined in the same direction with respect to the tire circumferential direction, and are each inclined (linearly extend) at the same angle relative to the tire circumferential direction, in the present embodiment. In the present embodiment, in the second crown block pair 9, the first inclined portion 25 of one of the second crown blocks 8 opposes the third inclined portion 27 of the other of the second crown blocks 8. For example, the second inclined portion 26 of one of the second crown blocks 8 opposes the second inclined portion 26 of the other of the second crown blocks 8. In the present embodiment, the third inclined portion 27 of one of the second crown blocks 8 opposes the first inclined portion 25 of the other of the second crown blocks 8. In other words, the crown longitudinal groove 23 is formed so as to zigzag. The crown longitudinal groove 23 having such a configuration exhibits a high shearing force on an off-road surface.

An angle α4 of the first inclined portion 25 relative to the tire circumferential direction is preferably less than an angle α5 of the second inclined portion 26 relative to the tire circumferential direction. Thus, the first inclined portion 25 disposed outward of the second inclined portion 26 in the tire circumferential direction allows muddy soil on a muddy road surface that is in contact with the second inclined portion 26 and the first inclined portion 25 to be easily discharged by utilizing rolling of the tire 1, and exhibits an edge effect in the tire axial direction to enhance sideslip resistance. The second inclined portion 26 allows a high shearing force to be exhibited in the tire circumferential direction to enhance traction performance and the like. From such a viewpoint, the angle α4 of the first inclined portion 25 is preferably 20° or more and more preferably 25° or more, and preferably 40° or less and more preferably 35° or less. The angle α5 of the second inclined portion 26 is preferably 40° or more and more preferably 45° or more, and preferably 60° or less and more preferably 55° or less.

An angle α6 of the third inclined portion 27 relative to the tire circumferential direction is preferably equal to the angle α4 of the first inclined portion 25. The “equal” means that an absolute value |α4-α6| of a difference between the angle α6 of the third inclined portion 27 and the angle α4 of the first inclined portion 25 is 0°, and also means that the absolute value |α4-α6| is 10° or less.

FIG. 3B is a cross-sectional view taken along a line B-B in FIG. 4. As shown in FIG. 3B, in each of the plurality of the second crown blocks 8, the second block wall surface 8s is inclined at an angle θ2 of 10 to 20° relative to the tread normal line n that is normal to the tread at the second crown block edge 8e. The second block wall surface 8s having such a configuration also allows stiffness of the second crown block 8 to be enhanced.

As shown in FIG. 1, each of the plurality of the crown blocks 5 includes a linearly extending shallow groove 15. The shallow groove 15 allows stiffness of each of the crown blocks 7, 8 to be appropriately reduced, allows an enveloping property to be enhanced, and allows traveling performance on a rocky road surface to be enhanced. The shallow groove 15 can allow traction performance and the like to be enhanced on an off-road surface while inhibiting chipping from occurring, as compared with a sipe. In the description herein, the sipe refers to a cut recess having a width of less than 1.5 mm. The grooves including the shallow groove 15 each refer to a dented recess having a groove width of 1.5 mm or more. In the description herein, the shallow groove represents a groove having a groove depth of 50% or less of either of block heights H1, H2 (shown in FIG. 3) of the crown blocks 7, 8.

Two shallow grooves 15 are disposed in each of the plurality of the first crown blocks 7. One shallow groove 15 is disposed in each of the plurality of the second crown blocks 8. In the present embodiment, the area A1 of the tread surface 7a of the first crown block 7 is larger than the area A2 of the tread surface 8a of the second crown block 8. Therefore, a difference between the stiffness of the first crown block 7 having the two shallow grooves 15 and the stiffness of the second crown block 8 having the one shallow groove 15 is reduced. Therefore, a difference between an amount of wear generated at the first crown block 7 and an amount of wear generated at the second crown block 8 is reduced.

In the first crown block 7 having the laterally elongated tread surface 7a, the shallow groove 15 extends in the tire circumferential direction. In the second crown block 8 having the longitudinally elongated tread surface 8a, the shallow groove 15 extends in the tire axial direction. The shallow grooves 15 having such a configuration allow stiffness of each of the first crown block 7 and the second crown block 8 in the tire circumferential direction and stiffness thereof in the tire axial direction to be maintained, to enhance wear resistance.

As shown in FIG. 2, each shallow groove 15 of the first crown block 7 is connected to the recess 11 of the first crown block 7. The shallow groove 15 having such a configuration contributes to appropriately reducing stiffness of the recess 11, promoting deformation of the recess 11 through contact and non-contact with the ground during running, and removing muddy soil that is inserted in the recess 11 from a muddy road surface, and stones and the like that are inserted in the recess 11 from a rocky road surface. In the present embodiment, the shallow groove 15 of the first crown block 7 is displaced from the vertex 11t. The shallow groove 15 having such a configuration allows stiffness to be ensured near the vertex 11t, and allows enhancement of a shearing force applied to the muddy soil by the vertex 11t.

The two shallow grooves 15 of the first crown block 7 extend in parallel with each other. The shallow groove 15 having such a configuration allows reduction of variation in stiffness of the first crown block 7 in the tire axial direction, to effectively exhibit an enveloping property. In the description herein, the “parallel” means that an absolute value |α8-α9| of a difference between angles α8 and α9 of the respective shallow grooves 15 relative to the tire axial direction is 0° and also means that the absolute value |α8-α9| is 10° or less. For example, the two shallow grooves 15 of the first crown block 7 extend so as to connect between the first lateral edges 13. The shallow groove 15 extends in parallel with the first lengthwise edge 14.

As shown in FIG. 4, the shallow groove 15 of the second crown block 8 is connected to an intersection K at which the second inclined portion 26 and the third inclined portion 27 intersect each other. The shallow groove 15 having such a configuration promotes, by running, deformation at the intersection K at which muddy soil on a muddy road surface is likely to be accumulated, and allows the muddy soil to be easily discharged. The shallow groove 15 of the second crown block 8 connects between the inner block edge 20 and the outer block edge 21. In the description herein, the shallow grooves 15 of the second crown block pair 9 extend in parallel with each other.

A groove depth D1 (shown in FIG. 3) of the shallow groove 15 disposed in each of the first crown block 7 and the second crown block 8 is preferably 30% or less of the block height H2 of each second crown block 8 and more preferably 25% or less of the block height H2. Since the groove depth D1 of each shallow groove 15 is 30% or less of the block height H2, high stiffness of the crown block 5 is maintained, and chipping can be inhibited. If the groove depth D1 of the shallow groove 15 is excessively small, an enveloping property may not be enhanced. Therefore, the groove depth D1 of the shallow groove 15 is preferably 5% or more of the block height H2 and more preferably 10% or more of the block height H2. From the same viewpoint, the groove width Wa of each shallow groove 15 is preferably 5% or more of the maximum width W2 (shown in FIG. 1) of each second crown block 8 and more preferably 7% or more of the maximum width W2, and preferably 15% or less of the maximum width W2 and more preferably 13% or less of the maximum width W2. In the present embodiment, the block height H2 of the second crown block 8 is equal to the block height H1 of the first crown block 7 (shown in FIG. 3).

In the present embodiment, the crown block 5 does not have grooves and sipes other than the shallow grooves 15. The crown block 5 having such a configuration has high wear resistance and chipping performance.

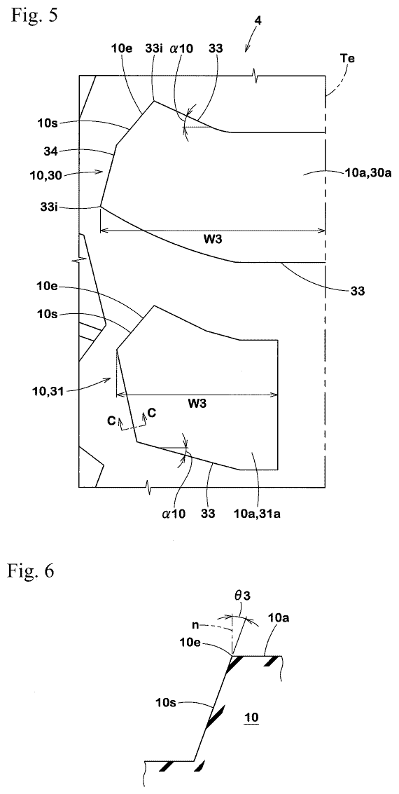

FIG. 5 is a plan view of the shoulder block row 4. FIG. 5 shows the shoulder block row 4 on the right side in FIG. 1. As shown in FIG. 5, the pair of the shoulder block rows 4 each include a plurality of shoulder blocks 10 aligned in the tire circumferential direction. The plurality of shoulder blocks 10 include first shoulder blocks 30 each having a tread surface 30a extending across the tread end Te inward and outward of the tread end Te in the tire axial direction, and second shoulder blocks 31 each having a tread surface 31a merely disposed inward of the tread end Te in the tire axial direction.

Each of the plurality of shoulder blocks 10 includes a shoulder block edge 10e that defines a tread surface 10a, and a shoulder block wall surface 10s extending inward from the shoulder block edge 10e in the tire radial direction. The shoulder block edge 10e includes a pair of lateral block edges 33, 33 extending in the tire axial direction, and a lengthwise block edge 34 extending in the tire circumferential direction so as to connect between inner ends 33i of the pair of lateral block edges 33 in the tire axial direction.

An angle α10 of each of the pair of lateral block edges 33 relative to the tire axial direction is 40° or less. The lateral block edge 33 having such a configuration exhibits high stiffness in the tire circumferential direction, and enhances wear resistance. The lateral block edge 33 inhibits the shoulder block 10 from falling in off-road running, and allows enhancement of a shearing force with respect to a muddy road surface and a scratching force with respect to a rocky road surface, to enhance off-road running stability.

Each of the plurality of shoulder blocks 10 is preferably a plain block having no sipes (not shown). In the present embodiment, each shoulder block 10 does not have grooves including shallow grooves as well as sipes. Thus, also when side camber is generated in off-road running, the shoulder block 10 comes into contact with the ground with high stiffness, so that excellent traction performance and the like are exhibited.

In order to effectively exhibit the above-described effect, the maximum width W3, in the tire axial direction, of each of the plurality of shoulder blocks 10 is preferably 20% or more of the tread width TW (shown in FIG. 1) and more preferably 25% or more of the tread width TW, and preferably 35% or less of the tread width TW and more preferably 30% or less of the tread width TW.

FIG. 6 is a cross-sectional view taken along a line C-C in FIG. 5. As shown in FIG. 6, the shoulder block wall surface 10s is inclined at an angle θ3 of 10 to 20° relative to the tread normal line n that is normal to the tread at the shoulder block edge 10e. The shoulder block wall surface 10s having such a configuration exhibits effects of enhancing stiffness of the shoulder block 10, enhancing wear resistance, and reducing sideslip of the block.

As shown in FIG. 1, in the present embodiment, the tread portion 2 includes a 4-block portion Xa in which the shoulder blocks 10 on both sides in the tire axial direction and the second crown block pair 9 are disposed on a tire axial direction line Y. In the present embodiment, the tread portion 2 includes a 3-block portion Xb in which the shoulder blocks 10 on both sides in the tire axial direction and the first crown block 7 are disposed on the tire axial direction line Y. Thus, in the present embodiment, the tread portion 2 is formed by the 4-block portion Xa or the 3-block portion Xb, and does not have a 5-block portion (not shown) in which five blocks are disposed on the tire axial direction line Y.

A land ratio of the tread portion 2 is preferably 40% or more and more preferably 45% or more and preferably 60% or less and more preferably 55% or less. Since the land ratio of the tread portion 2 is 40% or more, stiffness of each shoulder block row 4 and each crown block 5 is ensured, and high wear resistance is maintained. Since the land ratio of the tread portion 2 is 60% or less, muddy soil and the like on a muddy road can be substantially scraped between each shoulder block row 4 and each crown block 5, so that off-road running stability can be enhanced. The land ratio represents a proportion of the total of the areas of the tread surfaces of the blocks to the area of the tread surface of an imaginary tread portion obtained by filling all the recesses between the blocks, and all the grooves (shallow grooves in the present embodiment) disposed in the blocks.

Although the particularly preferred embodiment of the present invention has been described above in detail, the present invention is not limited to the illustrated embodiment, and various modifications can be made to implement the present invention.

### EXAMPLES

Pneumatic tires having a basic pattern shown in FIG. 1 were produced, and tested for wear resistance and sideslip resistance. The test methods and the common specifications were as follows.
Tire size: 35×12.50R20LT
Rim: 10.0JJ×20
Tire internal pressure: 450 kPa

### <Wear Resistance>

One test driver drove the following test vehicle to which the test tires were mounted, on a dry asphalt road surface in a test course. After the running, the test driver visually evaluated a state in which the tread portion was worn. The results were indicated as scores with the score of Comparative Example 1 being 100. The greater the value was, the less the wear was and the more excellent wear resistance was.
Test vehicle: four-wheel-drive vehicle having an engine displacement of 4700 cc
Positions at which the test tires were mounted: all wheels

### <Sideslip Resistance>

One test driver drove the above-described test vehicle to which the test tires were mounted, on an off-road test course. The test driver made sensory evaluation for the frequency and the extent (degree) of sideslip during running. The results were indicated as scores with the score of Comparative Example 1 being 100. The greater the value was, the less the frequency and the extent of sideslip were and the more excellent the sideslip resistance was.

Table 1 indicates the test results.

TABLE 1

| | Comp. | | | | | | | | |
|---|---|---|---|---|---|---|---|---|---|
| | Ex. 1 | Ex. 1 | Ex. 2 | Ex. 3 | Ex. 4 | Ex. 5 | Ex. 6 | Ex. 7 | Ex. 8 |
| L1/W1 | 1.0 | 0.9 | 0.6 | 0.4 | 0.6 | 0.6 | 0.6 | 0.6 | 0.6 |
| L2/W2 | 1.8 | 1.8 | 1.8 | 1.5 | 1.8 | 1.8 | 1.8 | 1.8 | 1.8 |
| α4, α5 (°) | 30, 50 | 30, 50 | 20, 40 | 30, 50 | 30, 50 | 30, 50 | 30, 50 | 30, 50 | 30, 50 |
| Presence or | present | present | present | absent | present | present | present | present | present |
| absence of | | | | | | | | | |
| recess | | | | | | | | | |
| α1 (°) | 100 | 100 | 100 | — | 100 | 80 | 100 | 100 | 100 |
| Presence or | present | present | present | present | present | present | absent | present | present |
| absence of | | | | | | | | | |
| shallow | | | | | | | | | |
| groove | | | | | | | | | |
| θ1, θ2 (°) | 15 | 15 | 15 | 15 | 15 | 15 | 15 | 10 | 15 |
| Land ratio | 50 | 50 | 50 | 50 | 50 | 50 | 50 | 50 | 60 |
| (%) | | | | | | | | | |
| Wear | 100 | 105 | 110 | 105 | 110 | 105 | 110 | 105 | 115 |
| resistance | | | | | | | | | |
| [Score: | | | | | | | | | |
| the greater the | | | | | | | | | |
| value was, the | | | | | | | | | |
| better the | | | | | | | | | |
| wear | | | | | | | | | |
| resistance | | | | | | | | | |
| was] | | | | | | | | | |
| Sideslip | 100 | 110 | 110 | 110 | 115 | 115 | 105 | 110 | 105 |
| resistance | | | | | | | | | |
| [Score: | | | | | | | | | |
| the greater the | | | | | | | | | |
| value was, the | | | | | | | | | |
| better the | | | | | | | | | |
| sideslip | | | | | | | | | |
| resistance | | | | | | | | | |
| was] | | | | | | | | | |

The test results indicate that the tires of the examples reduced sideslip while enhancing wear resistance, as compared with the tire of the comparative example.

### [Additional Note]

The present invention includes the following aspects.

### [Invention 1]

A tire including a tread portion, in which
the tread portion includes a pair of shoulder block rows, and a plurality of crown blocks disposed between the pair of shoulder block rows,
the crown blocks include a plurality of first crown blocks and a plurality of second crown blocks,
the plurality of second crown blocks are disposed such that a second crown block pair in which the two second crown blocks are disposed adjacent to each other in a tire axial direction so as to overlap each other in a tire circumferential direction repeatedly appears in the tire circumferential direction,
each of the plurality of first crown blocks is disposed one by one between the second crown block pairs adjacent to each other in the tire circumferential direction,
each of the plurality of first crown blocks has a laterally elongated tread surface in which a maximum length in the tire circumferential direction is less than a maximum width in the tire axial direction, and
each of the plurality of second crown blocks has a longitudinally elongated tread surface in which a maximum length in the tire circumferential direction is greater than a maximum width in the tire axial direction.

### [Invention 2]

The tire according to Invention 1, in which
a ratio (L1/W1) of the maximum length L1 of the laterally elongated tread surface in the tire circumferential direction to the maximum width W1 thereof in the tire axial direction is 0.4 to 0.8, and
a ratio (L2/W2) of the maximum length L2 of the longitudinally elongated tread surface in the tire circumferential direction to the maximum width W2 thereof in the tire axial direction is 1.3 to 2.0.

### [Invention 3]

The tire according to Invention 1 or 2, in which an absolute value |A1-A2| of a difference between an area A1 of the tread surface of each of the first crown blocks and an area A2 of the tread surface of each of the second crown blocks is 40% or less of a smaller one of the area A1 or the area A2.

### [Invention 4]

The tire according to any one of Inventions 1 to 3, in which
each of the plurality of first crown blocks includes a first crown block edge that defines the tread surface,
the first crown block edge includes a recess including a V-shaped edge that is recessed toward an inner side of the tread surface, in a planar view of a tread, and
an angle formed by the V-shaped edge is 80 to 120°.

### [Invention 5]

The tire according to Invention 4, in which the two recesses are disposed in each of the first crown blocks.

### [Invention 6]

The tire according to any one of Inventions 1 to 5, in which each of the plurality of crown blocks includes a linearly extending shallow groove.

### [Invention 7]

The tire according to Invention 6, in which the two shallow grooves are disposed in each of the plurality of first crown blocks, and the one shallow groove is disposed in each of the plurality of second crown blocks.

### [Invention 8]

The tire according to Invention 6 or 7, in which
each of the plurality of first crown blocks includes a first crown block edge that defines the tread surface,
the first crown block edge includes a recess including a V-shaped edge that is recessed toward an inner side of the tread surface, in a planar view of a tread, and
the shallow groove of each of the first crown blocks is connected to the recess.

### [Invention 9]

The tire according to any one of Inventions 6 to 8, in which
a groove depth of the shallow groove is 30% or less of a block height of each of the second crown blocks, and
a groove width of the shallow groove is 5% to 15% of the maximum width W2 of each of the second crown blocks in the tire axial direction.

### [Invention 10]

The tire according to Invention 4, in which
each of the plurality of first crown blocks includes a first block wall surface extending inward from the first crown block edge in a tire radial direction and outward of the tread surface, and
the first block wall surface is inclined at an angle of 10 to 20° relative to a tread normal line that is normal to the tread at the first crown block edge.

### [Invention 11]

The tire according to any one of Inventions 1 to 10, in which
each of the plurality of second crown blocks includes a second crown block edge that defines the tread surface, and a second block wall surface extending inward from the second crown block edge in the tire radial direction and outward of the tread surface, and,
the second block wall surface is inclined at an angle of 10 to 20° relative to a tread normal line that is normal to the tread at the second crown block edge.

### [Invention 12]

The tire according to Invention 11, in which
the second crown block edges of the second crown block pair include inner block edges opposing each other,
each inner block edge includes a first inclined portion that includes a first end of the inner block edge in a longitudinal direction and is inclined relative to the tire circumferential direction toward a first side, and a second inclined portion that is connected to the first inclined portion, and is inclined toward a side opposite to the first side,
an angle of the first inclined portion relative to the tire circumferential direction is 20 to 40°, and
an angle of the second inclined portion relative to the tire circumferential direction is 40 to 60°.

### [Invention 13]

The tire according to any one of Inventions 1 to 12, in which
the tread portion includes a tread end,
each of the pair of shoulder block rows includes a plurality of shoulder blocks aligned in the tire circumferential direction, and
the plurality of shoulder blocks include a first shoulder block extending across the tread end inward and outward of the tread end in the tire axial direction, and a second shoulder block merely disposed inward of the tread end in the tire axial direction.

### [Invention 14]

The tire according to Invention 13, in which a maximum length of each of the plurality of shoulder blocks in the tire axial direction is 20% to 35% of a tread width.

### [Invention 15]

The tire according to Invention 13 or 14, in which
each of the plurality of shoulder blocks includes a shoulder block edge that defines a tread surface,
the shoulder block edge includes a pair of lateral block edges extending in the tire axial direction, and a lengthwise block edge extending in the tire circumferential direction so as to connect between inner ends of the pair of lateral block edges in the tire axial direction, and
an angle of each of the pair of lateral block edges relative to the tire axial direction is 40° or less.

### [Invention 16]

The tire according to any one of Inventions 13 to 15, in which each of the plurality of shoulder blocks is a plain block having no sipes.

### [Invention 17]

The tire according to any one of Inventions 1 to 16, in which a land ratio of the tread portion is 40% to 60%.

What is claimed is:

1. A tire comprising
a tread portion, wherein
the tread portion includes a pair of shoulder block rows, and a plurality of crown blocks disposed between the pair of shoulder block rows,
the crown blocks include a plurality of first crown blocks and a plurality of second crown blocks,
the plurality of second crown blocks are disposed such that a second crown block pair in which the two second crown blocks are disposed adjacent to each other in a tire axial direction so as to overlap each other in a tire circumferential direction repeatedly appears in the tire circumferential direction,
each of the plurality of first crown blocks is disposed one by one between the second crown block pairs adjacent to each other in the tire circumferential direction,
each of the plurality of first crown blocks has a laterally elongated tread surface in which a maximum length in the tire circumferential direction is less than a maximum width in the tire axial direction, and
each of the plurality of second crown blocks has a longitudinally elongated tread surface in which a maximum length in the tire circumferential direction is greater than a maximum width in the tire axial direction.

2. The tire according to claim 1, wherein
a ratio (L1/W1) of the maximum length L1 of the laterally elongated tread surface in the tire circumferential direction to the maximum width W1 thereof in the tire axial direction is 0.4 to 0.8, and
a ratio (L2/W2) of the maximum length L2 of the longitudinally elongated tread surface in the tire circumferential direction to the maximum width W2 thereof in the tire axial direction is 1.3 to 2.0.

3. The tire according to claim 1, wherein an absolute value |A1-A2| of a difference between an area A1 of the tread surface of each of the first crown blocks and an area A2 of the tread surface of each of the second crown blocks is 40% or less of a smaller one of the area A1 or the area A2.

4. The tire according to claim 1, wherein
each of the plurality of first crown blocks includes a first crown block edge that defines the tread surface,
the first crown block edge includes a recess including a V-shaped edge that is recessed toward an inner side of the tread surface, in a planar view of a tread, and
an angle formed by the V-shaped edge is 80 to 120°.

5. The tire according to claim 4, wherein the two recesses are disposed in each of the first crown blocks.

6. The tire according to claim 1, wherein each of the plurality of crown blocks includes a linearly extending shallow groove.

7. The tire according to claim 6, wherein the two shallow grooves are disposed in each of the plurality of first crown blocks, and the one shallow groove is disposed in each of the plurality of second crown blocks.

8. The tire according to claim 7, wherein
each of the plurality of first crown blocks includes a first crown block edge that defines the tread surface,
the first crown block edge includes a recess including a V-shaped edge that is recessed toward an inner side of the tread surface, in a planar view of a tread, and
the shallow groove of each of the first crown blocks is connected to the recess.

9. The tire according to claim 6, wherein
a groove depth of the shallow groove is 30% or less of a block height of each of the second crown blocks, and
a groove width of the shallow groove is 5% to 15% of the maximum width W2 of each of the second crown blocks in the tire axial direction.

10. The tire according to claim 4, wherein
each of the plurality of first crown blocks includes a first block wall surface extending inward from the first crown block edge in a tire radial direction and outward of the tread surface, and
the first block wall surface is inclined at an angle of 10 to 20° relative to a tread normal line that is normal to the tread at the first crown block edge.

11. The tire according to claim 1, wherein
each of the plurality of second crown blocks includes a second crown block edge that defines the tread surface, and a second block wall surface extending inward from the second crown block edge in a tire radial direction and outward of the tread surface, and,
the second block wall surface is inclined at an angle of 10 to 20° relative to a tread normal line that is normal to a tread at the second crown block edge.

12. The tire according to claim 11, wherein
the second crown block edges of the second crown block pair include inner block edges opposing each other,
each inner block edge includes a first inclined portion that includes a first end of the inner block edge in a longitudinal direction and is inclined relative to the tire circumferential direction toward a first side, and a second inclined portion that is connected to the first inclined portion, and is inclined toward a side opposite to the first side,
an angle of the first inclined portion relative to the tire circumferential direction is 20 to 40°, and
an angle of the second inclined portion relative to the tire circumferential direction is 40 to 60°.

13. The tire according to claim 1, wherein
the tread portion includes a tread end,
each of the pair of shoulder block rows includes a plurality of shoulder blocks aligned in the tire circumferential direction, and
the plurality of shoulder blocks include a first shoulder block extending across the tread end inward and outward of the tread end in the tire axial direction, and a second shoulder block merely disposed inward of the tread end in the tire axial direction.

14. The tire according to claim 13, wherein a maximum length of each of the plurality of shoulder blocks in the tire axial direction is 20% to 35% of a tread width.

15. The tire according to claim 13, wherein
each of the plurality of shoulder blocks includes a shoulder block edge that defines a tread surface,
the shoulder block edge includes a pair of lateral block edges extending in the tire axial direction, and a lengthwise block edge extending in the tire circumferential direction so as to connect between inner ends of the pair of lateral block edges in the tire axial direction, and
an angle of each of the pair of lateral block edges relative to the tire axial direction is 40° or less.

16. The tire according to claim 13, wherein each of the plurality of shoulder blocks is a plain block having no sipes.

17. The tire according to claim 1, wherein a land ratio of the tread portion is 40% to 60%.
